(19) United States
(12) Patent Application Publication
(10) Pub. No.: US 2023/0102404 A1
(43) Pub. Date: Mar. 30, 2023

(54) CONTROLLING ELECTRONIC DEVICE DATA CONNECTION CREDENTIALS

(71) Applicant: KYNDRYL, INC., New York, NY (US)

(72) Inventors: James Clive Hunter, Edinburgh (GB); Prabhu Baskar Jagadesan, COIMBATORE (IN)

(21) Appl. No.: 17/488,834

(22) Filed: Sep. 29, 2021

(51) Int. Cl. H04L 29/06

(52) U.S. Cl. CPC H04L 63/108; H04L 63/08

(57) ABSTRACT

A method, computer program product, and computer system for controlling connection credentials for uninterrupted connection between a target data source and a data ingestor. The method includes providing at least two credential sets for access to resources of the target data source by the data ingestor, each credential set having a credential and a common expiry period and interleaved expiry times. The method allocates a credential set as a current credential set with the one or more other credential sets as one or more backup credential sets. The method automatically swaps the current credential set and a backup credential set before the expiry of the current credential set and updates a backup credential set that includes the common expiry period set and a new credential that replaces a previous credential.

### BACKGROUND

The present invention relates to connection credentials, and more specifically, to controlling connection credentials to provide uninterrupted connection and continuous availability to data over the connection.

Connection credentials are used in a large number of situations to provide authentication and authorization for access to data held at various types of data stores. As an example, data integrations between a data warehouse and a source operational data store often rely on credentials based authentication and authorization.

Connection credentials are generally required to expire and to be replaced with different credentials. Credentials may include identifiers, passwords, keys, certificates, or other types of authentication evidence. When credentials expire, there is typically a process for updating the credentials that takes some time and is therefore not instantaneous.

In some cases, the data source to which the credentials apply is owned by a different party (e.g., a separate company) and it is necessary to transmit a password request to the different party requiring a manual reset by the different party which may lead to an interrupted connection.

The manual reset becomes problematic when real time data feeds are involved in the connection as there may be a break in the connection and therefore the data availability.

### SUMMARY

Embodiments of the present invention provide a method, a computer program product and a computer system, for controlling connection credentials for uninterrupted connection between a target data source and a data ingestor. One or more processors of a computer system provide at least two credential sets for access to resources of the target data source by the data ingestor. Each credential set of the at least two credential sets has a credential and a common expiry period and interleaved expiry times. The one or more processors allocate a credential set of the at least two credential sets as a current credential set with one or more other credential sets of the at least two credential sets as one or more backup credential sets. The one or more processors automatically swap the current credential set and a backup credential set before expiry of the current credential set. The one or more processors update, prior to the swapping, a backup credential set of the one or more backup credential sets, wherein the updated backup credential set comprises the common expiry period set and a new credential that replaces a previous credential.

### BRIEF DESCRIPTION OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings.

Embodiments of the present invention will now be described, by way of example only, with reference to the accompanying drawings.

FIG. 1 is a block diagram of an example embodiment of a connection credential environment and a credential control system, in accordance with embodiments of the present invention.

FIG. 2 is a flow diagram of an example embodiment of a method, in accordance with embodiments of the present invention.

FIG. 3 is a schematic diagram of an example credential update, in accordance with an aspect of a method in accordance with embodiments of the present invention.

FIG. 4A is a schematic diagram of an example credential update flow, in accordance with an aspect of a method in accordance with embodiments of the present invention.

FIG. 4B is a schematic diagram of another example credential update flow, in accordance with an aspect of a method in accordance with embodiments of the present invention.

FIG. 4C is a schematic diagram of another example credential update flow, in accordance with an aspect of a method in accordance with embodiments of the present invention.

FIG. 5 is a block diagram of an example embodiment of a credential control system, in accordance with an aspect of a method in accordance with embodiments of the present invention.

FIG. 6 is a block diagram of an embodiment of a computer system or cloud server in which embodiments of the present invention may be implemented.

FIG. 7 is a schematic diagram of a cloud computing environment in which embodiments of the present invention may be implemented.

FIG. 8 is a diagram of abstraction model layers of a cloud computing environment in which embodiments of the present invention may be implemented.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION

Embodiments of a method, system, and computer program product are provided for controlling connection credentials for uninterrupted connection between a target data source and a data ingestor. The target data source may take the form of any data source from which data access is required with uninterrupted availability.

The uninterrupted connection and uninterrupted availability is an improvement in the technical field of computer security generally and more particularly in the technical field of controlling access to data of a target data source such as a data warehouse and a source operational data store that relies on credentials based authentication and authorization of the data for access to the target data source.

The data ingestor may be a system having a network connection to the target data source and authorized access to data of the target data source. The data access may be required in real time. The network connection may be a local network, or a remote network such as a cloud system.

An example target data source and data ingestor may be a data warehouse and a source operational data store that relies on credentials based authentication and authorization of the data ingestor for access to data of the target data source. In another example, the target data source may be an application programming interface (API) with access required by a client system. In one embodiment, the target data source is an application programming interface that uses real time technology that processes information in data streams.

Systems accessing the target data source may have a dependency on non-interrupted real time data feeds. An example of real time services may be services delivered by customer data integration (CDI) to internal service delivery clients. Another example is multi-cloud management platforms providing real time services to clients.

There following two example scenarios that may be considered. Firstly, a credential provider (i.e., the data ingestor) may have an application programming interface (API) that may be invoked to reset a password; i.e., a fully automated system. A small piece of code may be provided to get the password reset automatically that does not require a new password. If a new password is required, the new password may be generated using a password generator.

Secondly, the target data source to which the credentials apply may be owned by a different party (e.g., a separate company) and it may be required to transmit a password request to the different party requiring a manual reset by the different party, which can be a lengthy process that may cause connectivity interruptions.

The described embodiments for controlling connection credentials for uninterrupted connection between a target data source and a data ingestor may provide two or more credential sets with interleaved expiry times, such that the two or more credential sets provide a current and one or more backup credential sets and can be updated without interruption to the connection, which may be applied in either of the above scenarios.

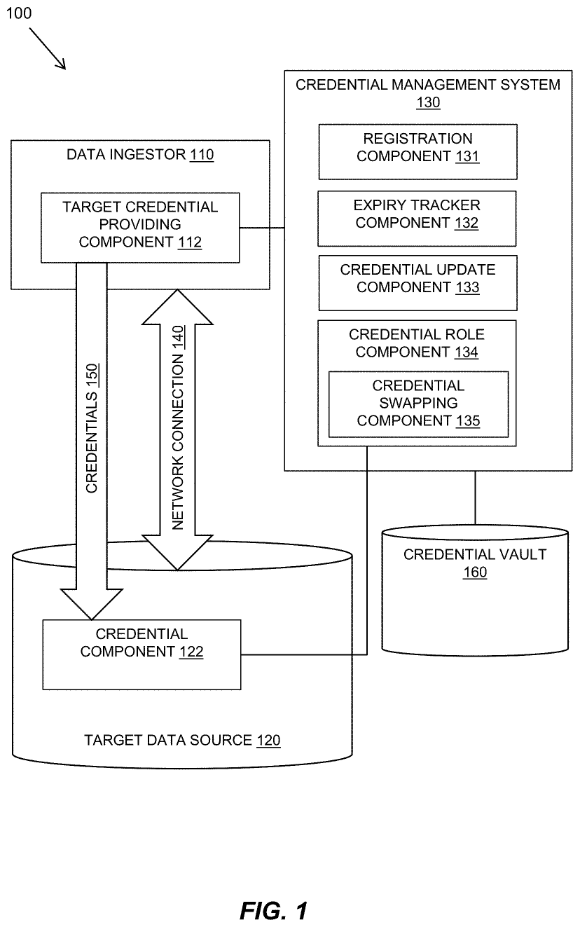

Referring to FIG. 1, a data access environment 100 is illustrated with a target data source 120 and a data ingestor 110. The target data source 120 is protected by a credential component 122 to control access by the data ingestors 110 to data of the target data source 120. The data ingestor 110 may include a target credential providing component 112 that provides registered credentials 150 to the credential component 122 for access to the target data source 120 to enable a network connection 140.

A credential control system 130 is provided that manages connection credentials for access to data of the target data source 120 by the data ingestor 110. The credential control system 130 may provide two or more credential sets for the data ingestor 110 with interleaved expiry times, such that the two or more credential sets provide a current and one or more backup credential sets and can be updated without interruption to the network connection 140.

The credential control system 130 may be local to the data ingestor 110 or to the target data source 120, or may be provided as a remote service. The credential control system 130 may include a registration component 131 for registering the data ingestor 110 and registering the two or more credential sets for access to data of the target data source 120.

The two or more credential sets may be stored in a credential vault 160 and may be used as a current credential set and one or more backup credential sets and may be configured to have a common expiry period and interleaved expiry times. The credential control system 130 may include an expiry tracker component 132 for tracking the expiry of the credential sets and a credential update component 133 for coordinating the updating of the credentials in the credential sets. A credential swapping component 135 of a credential role component 134 may automatically swap the credential sets between being a current credential set and a backup credential set.

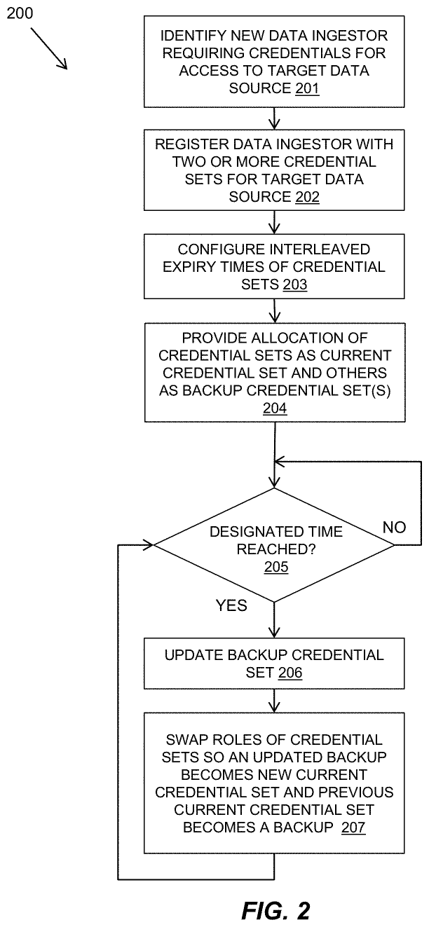

Referring to FIG. 2, a flow diagram 200 shows an example embodiment of the described method for controlling connection credentials for uninterrupted connection between a target data source and a data ingestor.

The method may identify 201 a new data ingestor requiring credentials for access to a target data source. The method may register 202 the data ingestor with two or more credential sets for the target data source.

The method may configure 203 the credential sets to have a common expiry period and interleaved expiry times. In an embodiment with two credential sets, the interleaved expiry times may overlap by half the common expiry period. In an embodiment with three credential sets, the interleaved expiry times may overlap by a third of the common expiry period. Therefore, the interleaved expiry times may overlap by the common expiry period divided by the number of credential sets. The method may provide 204 an allocation of a first credential set as a current credential set and the other one or more credential sets as backup credential sets. The number (N) of credential sets is a positive integer of at least 2 (e.g., 2, 3, 4, 5, 6, etc.).

The method may determine 205 if a designated time is reached. If so, the second credential set is updated 206 as the backup credential set in the background. If not, the method loops back to step 205 to again determine if the designated time is reached.

The role of the credential sets is then swapped 207. The swap 207 results in an updated backup credential set changing from a backup credential set to the new current credential set and the credential set that was the previous current credential set becomes a backup credential set. If there are two credential sets, the sets alternate between being a current and a backup credential set. If there are three or more credential sets, the role of the current credential set rotates through the credential sets. The role swapping 207 may be offset or delayed from the credential set updating 206 to provide a tolerance in the credential set up.

After step 207 has been performed, the method loops back to step 205 to again determine if the designated time is reached.

The method of FIG. 2 is implemented with uninterrupted updated credential sets swapping in or “flip-flopping” at regular intervals while maintaining one or more backup credential sets. The designated time may be the common expiry period divided by the number of credential sets.

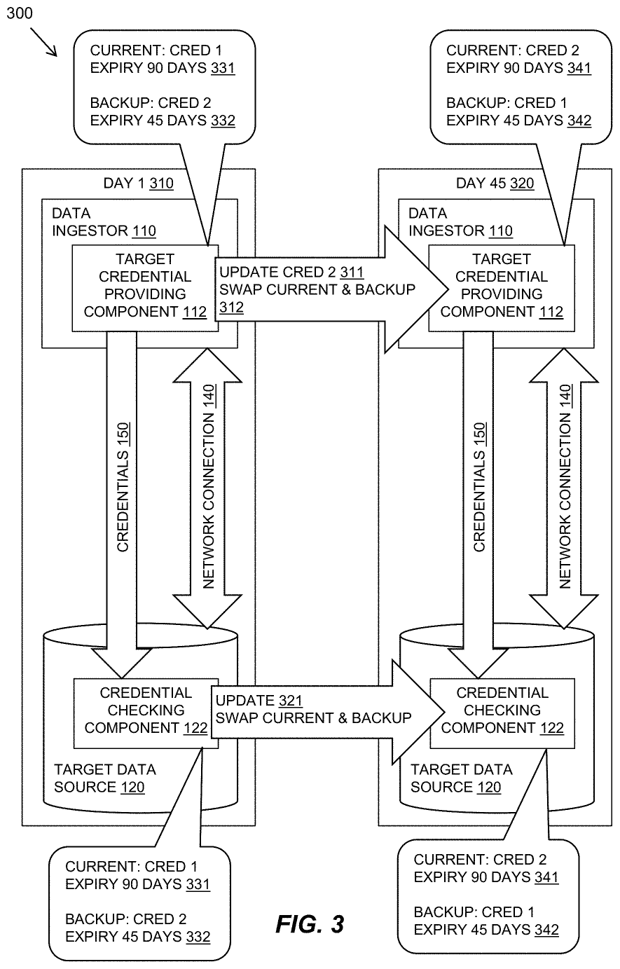

Referring to FIG. 3, a schematic diagram 300 shows an example embodiment of a credential swap in an environment as described in relation to FIG. 1. The environment of FIG. 1 includes a target credential providing component 112 of a data ingestor 110 providing credentials 150 to a credential component 122 of a target data source 120, with a network connection 140 between the data ingestor 110 and the target data source 120. Two credential sets may be registered with the target data source 120 that uses real time technology that processes information in data streams.

In this example, the first set of credentials (Cred 1) and the second set of credentials (Cred 2) both have an expiry period of 90 days. At day 1 310, the current credential set 331 is Cred 1 which is used initially for integration to the target data source 120 with Cred 1 having a full expiry period of 90 days and the backup credential set 332 being Cred 2 with an expiry period of 45 days for the initial period.

A swap over of credential sets takes place at day 45 320, which is halfway through the expiry period of the current credential set, Cred 1. Just prior to this swapping time, there is an update at the target credential providing component 112 to update 311 Cred 2 to an updated credential set and to then swap 312 the current and backup credential sets so that Cred 2 becomes the current credential set 341 with an expiry period of 90 days (as it has just been updated) and Cred 1 becomes the backup credential set 342 with its remaining 45 days of expiry period left to run. At this time the credential checking component 122 at the target data source 120 is also updated 321 to verify the new current credential set and backup credential set. The updated credential set has a new credential (e.g., a new password) and an expiry period of 90 days.

When Cred 1 is swapped out after 45 days, Cred1 has 45 days left to run on Cred1's password, with Cred 2 at this point being swapped in and having 90 days to run. This means there are two “current” passwords giving 45 days of dual coverage. When the Cred 1 password expires 45 days later, there is still 45 days to run on Cred 2. The Cred 1 password is changed and swapped back in, which may occur just before Cred 1 expires to provide a little offset. This process flip-flops every 45 days, giving 45 days to renew the new credential.

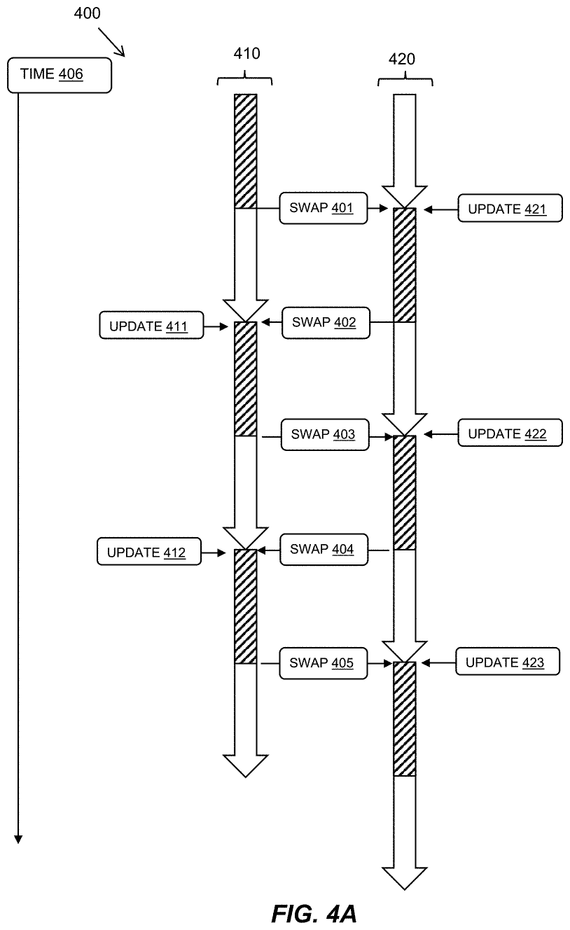

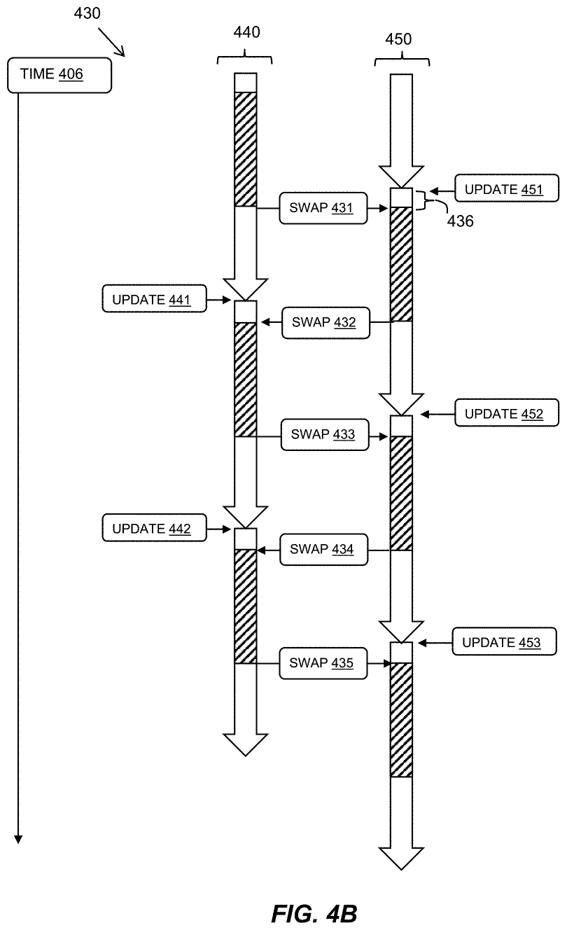

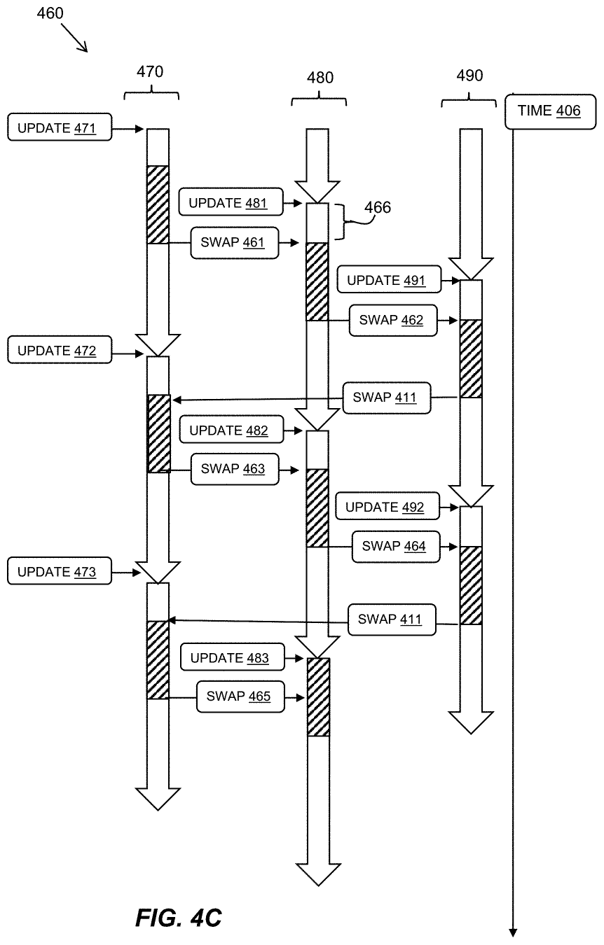

Referring to FIGS. 4A and 4B, two schematic diagrams 400, 430 show example embodiments of the repeated swapping or “flip-flopping” between two the credential sets over time 406. The diagonal hashing shows the credential set that is the current credential set, with the other credential set being the backup credential set.

FIG. 4A shows the swapping of two credential sets with updates to the swapped in credential set happening simultaneously with the swapping. FIG. 4B shows an alternative embodiment in which the update to a credential set takes place during its time as the backup credential set a short time period before the swapping takes place. This provides an error tolerance for a delay in the credential set update.

FIG. 4A shows a first credential set 410 and a second credential set 420. The first credential set 410 and the second credential set 420 have a same duration of expiry period (T) but are staggered such that the first credential set 410 expires at a halfway time (T/2) in the second credential set 420 and vice versa.

The first credential set 410 starts as the current credential set (with the current credential set shown by the hashing) and the second credential set 420 starts as the backup credential set. The second credential set 420 may start with a shortened initial expiry period of half the same duration of expiry period (i.e., T/2) to ensure that the expiry periods are interleaved and expire at alternating times. The first credential set 410 and the second credential set 420 each comprise a credential (e.g., identifiers (IDs), passwords, keys, certificates, or other types of authentication and/or authorization evidence) for authenticating and/or authorizing the data ingestor 110 to enforce data security.

At a time halfway (T/2) through the expiry period of the first credential set 410, the second credential set 420 is updated 421 to have an expiry period of T and the roles of the first and second credential sets are swapped 401 so that the second credential set 420 becomes the current credential set and the first credential set 410 becomes the backup credential set.

At a time halfway through the expiry period of the second credential set 420, the first credential set 410 is updated 411 and the roles of the first and second credential sets are swapped 402 back so that the first credential set 410 becomes the current credential set and the second credential set 420 becomes the backup credential set.

The preceding steps repeat with an additional update 422 to the second credential set 420 and role swap 403, followed by a further update 412 to the first credential set 410 and role swap 404, followed by a further update 423 to the second credential set 420 and role swap 405, and so on.

The preceding process is characterized by an alternation of updating the backup credential set and swapping the current and backup credential sets. The updated backup credential set has a new credential (e.g., a new password) that replaces a previous credential and the common (i.e., same) expiry period of T.

FIG. 4B shows a similar process to that of FIG. 4A, with a first credential set 440 and a second credential set 450. In FIG. 4B, the updates 451, 441, 452, 442, 453 occur a short time period 436 (e.g., 0.01T, 0.05T, 0.10T, 0.20T, 0.30T, etc.) before the swapping of roles 431-435 takes place, which allows for a tolerance in the credential update. The short time period 436 is a time offset from the update, enabling swapping the current credential set and the backup credential set before the expiry of the current credential set and providing a remaining validity period of a swapped out current credential set as a backup credential set.

FIG. 4C shows a schematic diagram 460 of another example embodiment in which the concept is extended to swapping between three credential sets to increase the backup by another credential set, which provides additional security as, if a credential set is locked unexpectedly, there is always a backup credential set that may be applied immediately, which ensures no real time failure due to not having a valid credential set.

In FIG. 4C there is a first credential set 470, a second credential set 480, and a third credential set 490. The first, second and third credential sets each have a common (i.e., same) expiry period (T) but are staggered such that the expiry of each credential set takes place at a different time, with the times being a third of the common expiry period. Each credential set takes the role of the current credential set for a period of a third of the common expiry period, it then takes a role as a backup credential set for a period of two thirds of the common expiry period. Therefore, two credential sets have the role of backup credential sets at a time providing extra security in the event that a credential set is locked. The two backup credential sets may be designated as a first backup and a second backup. In this way, the credential sets may be rotated through the roles of current, first backup, and second backup.

A common expiry period is defined to be a same expiry period.

As in FIG. 4B, the updates 471-473, 481-483, 491-492 occur a short time period 466 before the swapping of roles 461-465 takes place, which allows for a tolerance in the credential update. This results in an offset between the roles and the update times.

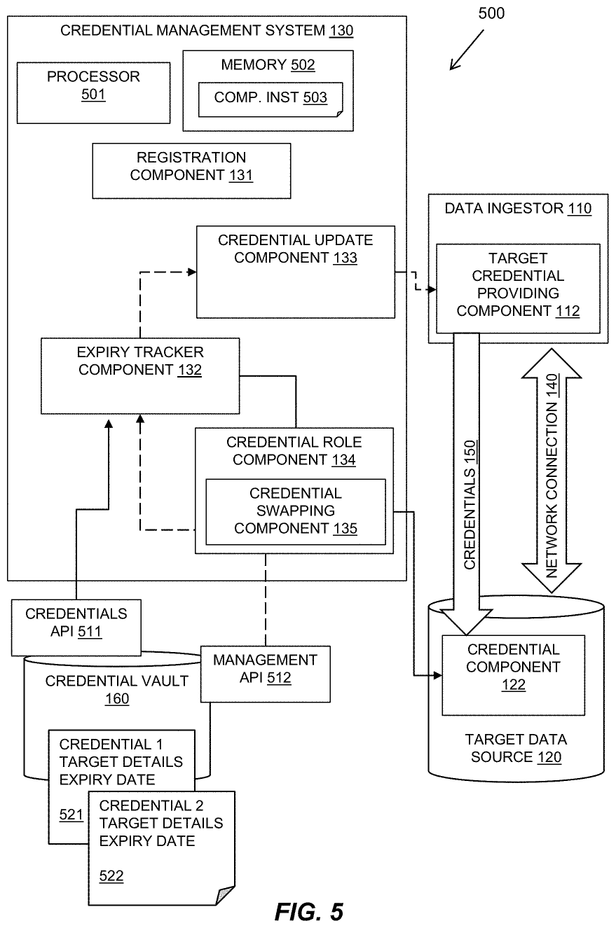

Referring to FIG. 5, a block diagram 500 shows the data access environment 500 of FIG. 1 with a credential control system 130 for controlling access credentials 150 for access by a data ingestor 110 to a target data source 120 to establish a network connection 140. FIG. 5 illustrates a credential reset flow shown in broken lines and a credential swapping flow shown in solid lines that may be controlled by a workflow orchestration.

The credential control system 130 may include at least one processor 501, a hardware module, or a circuit for executing the functions of the described components which may be software units executing on the at least one processor. Multiple processors running parallel processing threads may be provided enabling parallel processing of some or all of the functions of the components. Memory 502 may be configured to provide computer instructions 503 to the at least one processor 501 to carry out the functionality of the components.

The credential control system 130 includes a registration component 131 and each time a new data ingestor 110 is identified to pull the data from a target data source 120, two or more credential sets are requested for providing access to the target data source. The two or more credential sets are stored in the credential vault 160.

The credential control system 130 includes a credential update component 133, for example, in the form of an identity and access control solution. The credential control system 130 also includes an expiry tracker component 132 that may be a polling module that acts as an automated reminder system for rotation of credentials at a configured time, such as at a half way time of the expiry period.

The credential vault 160 may store credential sets 521, 522 including the credential details, the target details, and the expiry data. The credential vault 160 may have a credentials API 511 for using the stored credentials and a control API 512 for updating and swapping the roles the stored credentials.

In the reset flow, the expiry tracker component 132 may determine that it is a credential reset time for one of the credential sets 521, 522 and may prompt the credential update component 133 to automatically or manually update the credential set for use by the target credential providing component 112 of the data ingestor 110. The control API 512 of the credential vault 160 may update the credentials of one of the credential sets 521, 522.

There are two example forms of credential update component 133 to be considered. Firstly, the data ingestor 110 may have an API that may be invoked to reset a password, i.e. a fully automated system. A small piece of code may be provided to get the password reset automatically that does not require a new password. If a new password is required, this may be generated using a password generator. Secondly, the target data source 120 to which the credentials apply may be owned by a different party (e.g. a separate company) and it may be required to put a password request into their process (i.e. it is a manual reset on their part). This can be a lengthy process which may cause connectivity interruptions.

In the swapping flow, the expiry tracker component 132 may determine that it is a credential swap time for the roles of the credential sets 521, 522 between the current and backup roles. The credential swapping component 135 may update the credential component 122 of the target data source 120 and may use the credentials API 511 to update the roles of the stored credentials 521, 522.

Many target data sources, such as APIs for applications that process information in data streams, rely on an expiring credential for authentication and authorization purposes. Systems using these targets that have a dependency on non-interrupted real time data feeds have an issue in the period when the target credential expires, especially if the credential renewal process is controlled by another entity.

This is true for many scenarios, with specific examples including: the real time services being delivered by customer data integration to service delivery clients and by multicloud platforms providing real time services to clients.

The described method and system concentrate on having a valid credential set, such as a user identifier and password, always available that can be flip-flopped into the connection credentials for a remote data source.

The described method and system provide an active credential that is always available even when the password control process is owned by another party, allowing real time connections to remote data sources to be maintained even when the remote system is controlled by another party.

This ensures that real time connections can be maintained despite potentially extended timelines for changing passwords on remote third party managed targets where the password control is the responsibility of the third party.

The described method and system may manage both cloud and data center scenarios.

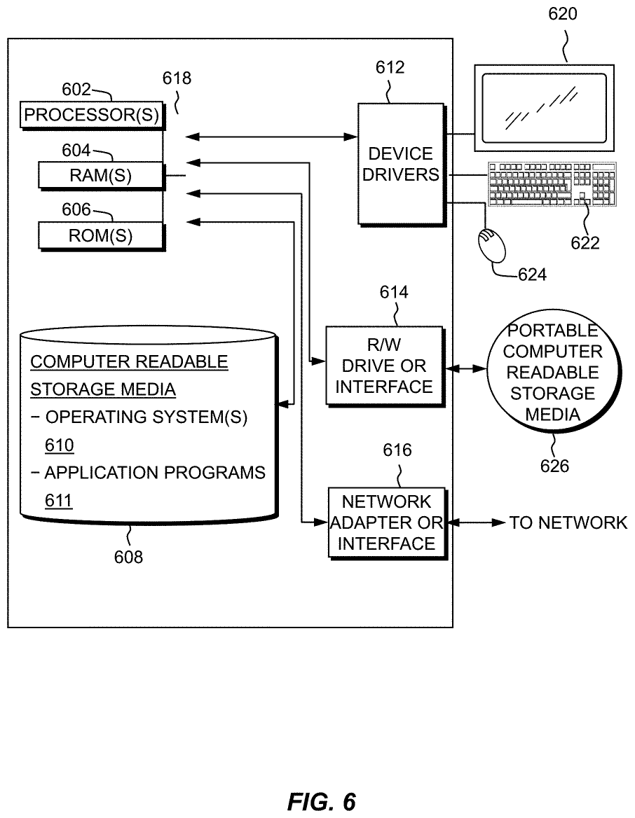

FIG. 6 depicts a block diagram of components of a computing system as used for the credential control system 130, in accordance with an embodiment of the present invention. It should be appreciated that FIG. 6 provides only an illustration of one implementation and does not imply any limitations with regard to the environments in which different embodiments may be implemented. Many modifications to the depicted environment may be made.

The computing system can include one or more processors 602, one or more computer-readable RAMs 604, one or more computer-readable ROMs 606, one or more computer readable storage media 608, device drivers 612, read/write drive or interface 614, and network adapter or interface 616, all interconnected over a communications fabric 618. Communications fabric 618 can be implemented with any architecture designed for passing data and/or control information between processors (such as microprocessors, communications and network processors, etc.), system memory, peripheral devices, and any other hardware components within the system.

One or more operating systems 610, and application programs 611, are stored on one or more of the computer readable storage media 608 for execution by one or more of the processors 602 via one or more of the respective RAMs 604 (which typically include cache memory). In the illustrated embodiment, each of the computer readable storage media 608 can be a magnetic disk storage device of an internal hard drive, CD-ROM, DVD, memory stick, magnetic tape, magnetic disk, optical disk, a semiconductor storage device such as RAM, ROM, EPROM, flash memory, or any other computer readable storage media that can store a computer program and digital information, in accordance with embodiments of the invention.

The computing system can also include a R/W drive or interface 614 to read from and write to one or more portable computer readable storage media 626. Application programs 611 on the computing system can be stored on one or more of the portable computer readable storage media 626, read via the respective R/W drive or interface 614 and loaded into the respective computer readable storage media 608.

The computing system can also include a network adapter or interface 616, such as a TCP/IP adapter card or wireless communication adapter. Application programs 611 on the computing system can be downloaded to the computing device from an external computer or external storage device via a network (for example, the Internet, a local area network or other wide area networks or wireless networks) and network adapter or interface 616. From the network adapter or interface 616, the programs may be loaded into the computer readable storage media 608. The network may comprise copper wires, optical fibers, wireless transmission, routers, firewalls, switches, gateway computers and edge servers.

The computing system can also include a display screen 620, a keyboard or keypad 622, and a computer mouse or touchpad 624. Device drivers 612 interface to display screen 620 for imaging, to keyboard or keypad 622, to computer mouse or touchpad 624, and/or to display screen 620 for pressure sensing of alphanumeric character entry and user selections. The device drivers 612, R/W drive or interface 614, and network adapter or interface 616 can comprise hardware and software stored in computer readable storage media 608 and/or ROM 606.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Cloud Computing

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

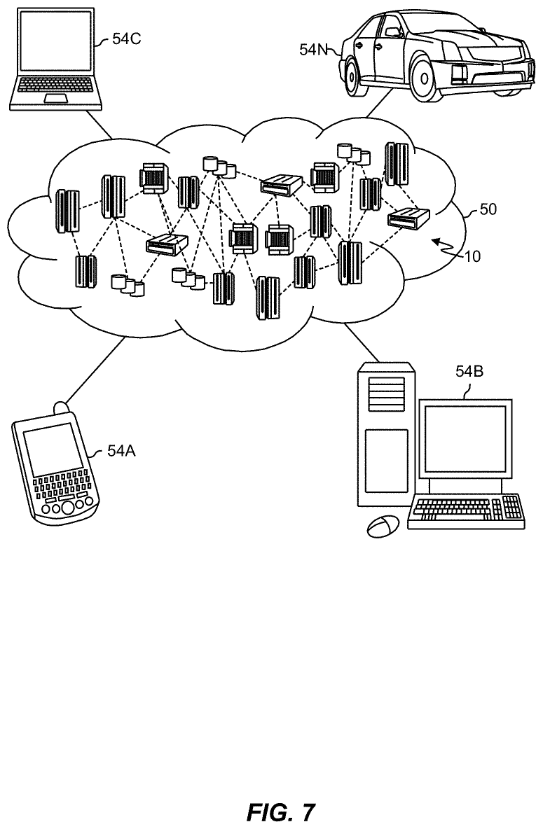

Referring now to FIG. 7, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 10 and cloud computing environment 50 can communicate with any type of computerized device over any type of network and/or network addressable connection (e.g., using a web browser).

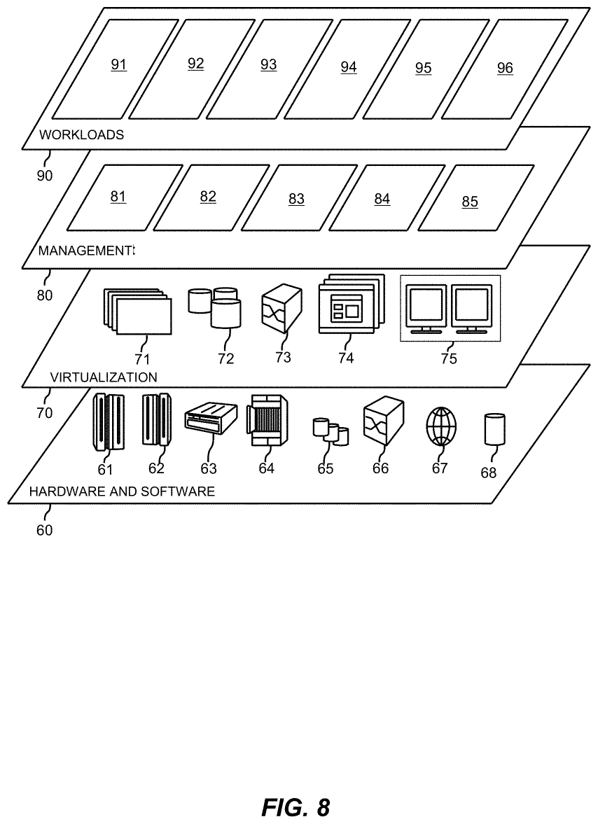

Referring now to FIG. 8, a set of functional abstraction layers provided by cloud computing environment 50 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and credential control processing 96.

A computer program product of the present invention comprises one or more computer readable hardware storage devices having computer readable program code stored therein, said program code executable by one or more processors to implement the methods of the present invention.

A computer system of the present invention comprises one or more processors, one or more memories, and one or more computer readable hardware storage devices, said one or more hardware storage device containing program code executable by the one or more processors via the one or more memories to implement the methods of the present invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Improvements and modifications can be made to the foregoing without departing from the scope of the present invention.

What is claimed is:

1. A method for controlling connection credentials for uninterrupted connection between a target data source and a data ingestor, said method comprising:
providing, by one or more processors of a computer system, at least two credential sets for access to resources of the target data source by the data ingestor, each credential set of the at least two credential sets having a credential and a common expiry period and interleaved expiry times;
allocating, by the one or more processors, a credential set of the at least two credential sets as a current credential set with one or more other credential sets of the at least two credential sets as one or more backup credential sets;
automatically swapping, by the one or more processors, the current credential set and a backup credential set before expiry of the current credential set updating, by the one or more processors prior to said swapping, a backup credential set of the one or more backup credential sets, wherein the updated backup credential set comprises the common expiry period set and a new credential that replaces a previous credential.

2. The method of claim 1, wherein the at least two credential sets consist of two credential sets, and wherein said swapping occurs at a time of half of the common expiry period of the current credential set.

3. The method of claim 1, wherein the at least two credential sets consist of three credential sets, and wherein said swapping occurs at a time of a third of the common expiry period of the current credential set.

4. The method of claim 3, wherein said swapping results in the current credential set becoming one backup credential set of two backup credential sets, wherein the two backup credential sets are designated as a first backup credential set and a second backup credential set, and wherein the three credential sets rotate between the roles of current credential set, the first backup credential set, and the second backup credential set at a time of said swapping.

5. The method of claim 1, wherein the updating of the backup credential set occurs at a time of said swapping which results in the backup credential set becoming the current credential set.

6. The method of claim 1, wherein the updating the backup credential set occurs at a defined time prior to said swapping to allow tolerance for the updating prior to said swapping.

7. The method of claim 1, wherein said swapping the current credential set and the backup credential set before the expiry of the current credential set provides a remaining validity period of a swapped out current credential set as a backup credential set.

8. The method of claim 1, wherein the target data source provides a live network connection.

9. The method of claim 1, wherein the target data source is an application programming interface that uses real time technology that processes information in data streams.

10. The method of claim 1, said method further comprising:
identifying, by the one or more processors, a new data ingestor for a target data source to pull the data from a target data source and in response, requesting two or more credential sets for providing access to the target data source.

11. A computer program product, comprising one or more computer readable hardware storage devices having computer readable program code stored therein, said program code containing instructions executable by one or more processors of a computer system to implement a method for controlling connection credentials for uninterrupted connection between a target data source and a data ingestor, said method comprising:
providing, by the one or more processors, at least two credential sets for access to resources of the target data source by the data ingestor, each credential set of the at least two credential sets having a credential and a common expiry period and interleaved expiry times;
allocating, by the one or more processors, a credential set of the at least two credential sets as a current credential set with one or more other credential sets of the at least two credential sets as one or more backup credential sets;
automatically swapping, by the one or more processors, the current credential set and a backup credential set before expiry of the current credential set; and
updating, by the one or more processors prior to said swapping, a backup credential set of the one or more backup credential sets, wherein the updated backup credential set comprises the common expiry period set and a new credential that replaces a previous credential.

12. The computer program product of claim 11, wherein the at least two credential sets consist of two credential sets, and wherein said swapping occurs at a time of half of the common expiry period of the current credential set.

13. The computer program product of claim 11, wherein the at least two credential sets consist of three credential sets, and wherein said swapping occurs at a time of a third of the common expiry period of the current credential set.

14. The computer program product of claim 13, wherein said swapping results in the current credential set becoming one backup credential set of two backup credential sets, wherein the two backup credential sets are designated as a first backup credential set and a second backup credential set, and wherein the three credential sets rotate between the roles of current credential set, the first backup credential set, and the second backup credential set at a time of said swapping.

15. The computer program product of claim 11, wherein the updating of the backup credential set occurs at a time of said swapping which results in the backup credential set becoming the current credential set.

16. A. computer system, comprising one or more processors, one or more memories, and one or more computer readable hardware storage devices, said one or more hardware storage devices containing program code executable by the one or more processors via the one or more memories to implement a method for controlling connection credentials for uninterrupted connection between a target data source and a data ingestor, said method comprising:
providing, by the one or more processors, at least two credential sets for access to resources of the target data source by the data ingestor, each credential set of the at least two credential sets having a credential and a common expiry period and interleaved expiry times;
allocating, by the one or more processors, a credential set of the at least two credential sets as a current credential set with one or more other credential sets of the at least two credential sets as one or more backup credential sets;
automatically swapping, by the one or more processors, the current credential set and a backup credential set before expiry of the current credential set; and
updating, by the one or more processors prior to said swapping, a backup credential set of the one or more backup credential sets, wherein the updated backup credential set comprises the common expiry period set and a new credential that replaces a previous credential.

17. The computer system of claim 1, wherein the at least two credential sets consist of two credential sets, and wherein said swapping occurs at a time of half of the common expiry period of the current credential set.

18. The computer system of claim 1, wherein the at least two credential sets consist of three credential sets, and wherein said swapping occurs at a time of a third of the common expiry period of the current credential set.

19. The computer system of claim 18, wherein said swapping results in the current credential set becoming one backup credential set of two backup credential sets, wherein the two backup credential sets are designated as a first backup credential set and a second backup credential set, and wherein the three credential sets rotate between the roles of current credential set, the first backup credential set, and the second backup credential set at a time of said swapping.

20. The computer system of claim 1, wherein the updating of the backup credential set occurs at a time of said swapping which results in the backup credential set becoming the current credential set.
